(19) United States
(12) Patent Application Publication
(10) Pub. No.: US 2024/0416434 A1
(43) Pub. Date: Dec. 19, 2024

(54) DRILL BIT EXTENSION

(71) Applicant: Kevin King, Meridian, ID (US)

(72) Inventor: Kevin King, Meridian, ID (US)

(21) Appl. No.: 18/210,010

(22) Filed: Jun. 14, 2023

(51) Int. Cl. B25B 21/00; B25B 23/00

(52) U.S. Cl. CPC B23B 51/126; B25B 23/0021; B23B 45/003; B23B 2231/04; Y10T 408/957

(57) ABSTRACT

A drill bit extension for use in, for example, tightening solar panel clamps or other situations in which a user traditionally would be required to kneel, bend, or otherwise extend to reach a bolt or other fastener to be tightened or loosened. The drill bit extension has a drill adapter end and a drill bit adapter end. A body extends between the two ends and houses a driveline. The body has a head that (or the body and head can be separate) that provides an angled extension for the drill bit adapter. Preferably the angle is 22.5 degrees, with the drill bit adapter extending at ninety degrees from the head.

### FIELD OF THE INVENTION

The presently disclosed technology relates to a tool for use in mounting solar panels and more specifically, a tool for mounting solar panels to solar racking by tightening the mid/end clamps without having to lay down, bend over, reach out, stretch or touch the solar panels.

### BACKGROUND OF THE INVENTION

A common way to mount solar panels to a structure is by using mounting rails (see picture 1-4). The structure can be a steel or aluminum frame which stands on top of posts, or the structure can be on the roof of a building, the wall of a building, or on the roof or walls of a mobile structure such as an RVs or vehicles. The example of solar panels which are mounted on the roof of a structure will be used for convenience, but is not meant to limit the claim. Solar panels are typically rectangular, and are mounted on a mounting rail with the use of mid/end clamps. Typically there are four clamps per solar panel, which means the tightening process must be repeated each time for each of the four different clamps. By tightening the mid/end clamps to the rails can be on the roof of a residence, building, or ground mounted structure, the mounting rails can be on the framework specifically for holding solar panels. The mounting rails can also be on other structures such as the walls of a building, or various places on mobile structures such as motor homes or RVs.

To tighten these clamps, one must lay on, hang over, reach out, or stretch over the solar panels with an impact gun, drill gun or wrench to tighten the clamps/fasteners. This issue causes a lot of stress on the solar panels and on the installer when maneuvering into position. When in the tightening position, the installer is in a very non ergonomic position which can cause unnecessary strain on the installers body and the solar panels. In doing this it puts the installers at risk of bodily injury or potentially causing damage to the solar panels such as broken photovoltaic cells, micro fractures, bend frames, or other damage.

During the summer months solar panels can reach well over 150 degrees to the touch and during the winter months, they can become very slippery. Accordingly, this process can become very tiring and dangerous for the solar installers as they must continually get up and down for every solar panel installed to the mounting rail. The goal is to mount each solar panel with as little energy, strain or potential injury to person or property as possible. What is needed is a tool which helps the installer of solar panels tighten the mid/end clamps to the solar racking without having to lay down and extend their body over the solar panels, in particular a tool which allows an installer to tighten the mid/end clamps from the standing position without bending, kneeling or laying down to install each and every solar panel.

### SUMMARY

The purpose of the Summary is to enable the public, and especially the scientists, engineers, and practitioners in the art who are not familiar with patent or legal terms or phraseology, to determine quickly from a cursory inspection, the nature and essence of the technical disclosure of the application. The Summary is neither intended to define the inventive concept(s) of the application, which is measured by the claims, nor is it intended to be limiting as to the scope of the inventive concept(s) in any way.

Disclosed is a solar panel installation tool for tightening solar panels to mounting rails. The tool includes a tool body, or shaft, which is an elongate piece of material which is typically metal, but other materials such as plastic or wood can alternatively be used. In one version of the device. The shaft can be constructed of a uniform piece, or two or more components. In other versions of the device the device support housing can be adjustable and has an adjustable handle. The tool body has a first end and a second end, the first end has a drill attachment, such as an impact drill tang, and the second end has an adapter, preferably a ⅜″ socket adapter. The body houses a drive line that transfers the rotational energy of a drill connected to the drill attachment to the adapter. Preferably a torque limiter is positioned between the drill attachment and the adapter to limit the rotational torque transferred to the adapter to prevent over tightening of the clamps on the solar panel. The torque limiter can either be positioned entirely within the housing or shaft, or positioned within a torque limiter housing, which forms a segment of the shaft. Alternatively the torque limiter can form the drill attachment to the drill bit extension.

In a preferred embodiment the tool is sixty one inches (61″) long with a handle approximately in the center of the tool. The handle is preferably configured with an adjustment mechanism such that the handle can be repositioned on the shaft. This adjustment mechanism can include a knob located on the bottom of the handle assembly that releases the handle from the shaft.

Proximate to the second end of this device there is an approximately 22.5 degree (or adjustable) elbow/head that provides an angle to the device to allow for the second end of the tool to tighten a bolt on the mid/end clamps which tighten the solar panels to the rail. For example, the head can be a ratcheting head to adjust the angle, or similar adjustable construction that allows the head to pivot and change the angle relative to the shaft. The head can be two pieces, such as an elbow and ninety degree application of the drive line.

In a preferred embodiment, the body of the device is a square housing. The square housing holds a fifty two inch (52″) extension bit drive connected to a twelve inch (12″) 90 degree angle drill bit drive with a ⅜ socket adapter attached. This allows for a socket to be connected to one end of the device and an impact drill or standard drill to turn the socket from the other end 61″ away. Alternate adapters can be utilized, such as larger socket drive adapters, drill bit holders, or other adapters. The adjustable handle allows the user to move the handle to a position which allows them to maintain control of the device no matter the length of their arms or position to the bolts needed to be tightened.

Another embodiment of the device includes the tool body being made of the main body which is attached to the adjustable elbow and 90 degree housing. The first arm has a cap block on the first end which holds and supports the 3″ impact drill bit extension which allows this tool to be connected to any impact or standard powered or battery operated drill. Connected to the 3″ impact drill bit extension is a 52″ drill bit extension shaft which connects to a 12″ flex 90 degree drill bit extension. A ⅜ drive socket attachment is inserted into the 90 degree bit attachment. This allows this device a total of 61″ of reach to tighten a bolt with any drill and standard ⅜″ socket without having to bend over, kneel, squat, stretch or bend over. With an adjustable handle & adjustable base, this device can work at virtually any angle, with virtually any drill, with any size ⅜″ socket for any person doing any kind of work requiring the extended reach and secure control. This tool allows the solar panels to be mounted without the installer having to bend over, lay down on or stretch out over the solar panels. This device is designed to eliminate issues of micro fractures being caused by installers laying on solar panels when installing them. Micro fractures can be the cause for catastrophic failures/fires to solar systems and or drastically reduce the output of production of a solar panel which has been a major issue for the solar industry in the last few years.

Still other features and advantages of the presently disclosed and claimed inventive concept(s) will become readily apparent to those skilled in this art from the following detailed description describing preferred embodiments of the inventive concept(s), simply by way of illustration of the best mode contemplated by carrying out the inventive concept(s). As will be realized, the inventive concept(s) is capable of modification in various obvious respects all without departing from the inventive concept(s). Accordingly, the drawings and description of the preferred embodiments are to be regarded as illustrative in nature, and not as restrictive in nature.

### BRIEF DESCRIPTION OF DRAWINGS

FIG. 1 illustrates the prior art use of a drill to secure a solar panel to a frame.

FIG. 2 illustrates a preferred embodiment of the invention in use to secure solar panel to a frame.

FIG. 3 illustrates a second use of the preferred embodiment of the invention to secure solar panels to a frame system on a pitched roof.

FIG. 4 illustrates a third use of the preferred embodiment of the invention to install solar panels on a frame system on a flat roof.

FIG. 5 illustrates a fourth use of the preferred embodiment of the invention to install solar panels on a frame system on a ground mounted structure.

FIG. 6 illustrates a perspective view of a preferred embodiment of the invention.

FIG. 6b illustrates a perspective view of the invention showing the internal components in dashed line.

FIG. 7 illustrates an isometric view of the embodiment of FIG. 6.

FIG. 8 illustrates a preferred embodiment of the internal components of a preferred embodiment of the invention.

FIG. 9 illustrates an isometric view of an angled head of a preferred embodiment of the invention.

FIG. 10 illustrates the preferred embodiment of a drill connector end of a preferred embodiment of the invention.

FIG. 11 illustrates an alternate embodiment of the invention having a telescoping shaft.

FIG. 12 illustrates the internal components of the embodiment shown in FIG. 11 writing an adjustable length drive.

FIG. 13 illustrates the preferred embodiment of an adjustable handle position on a shaft configured for the adjustable handle.

FIG. 14 illustrates a perspective view of a torque limiter positioned within a torque limiter housing.

FIG. 15 illustrates the torque limiter of FIG. 1 with the housing removed.

FIG. 16 illustrates a partially exploded view of a preferred embodiment of the first end of the drill bit extension showing the drill attachment and a torque limiter positioned on the drive line.

### DETAILED DESCRIPTION OF THE INVENTION

While the presently disclosed inventive concept(s) is susceptible of various modifications and alternative constructions, certain illustrated embodiments thereof have been shown in the drawings and will be described below in detail. It should be understood, however, that there is no intention to limit the inventive concept(s) to the specific form disclosed, but, on the contrary, the presently disclosed and claimed inventive concept(s) is to cover all modifications, alternative constructions, and equivalents falling within the spirit and scope of the inventive concept(s) as defined in the claims.

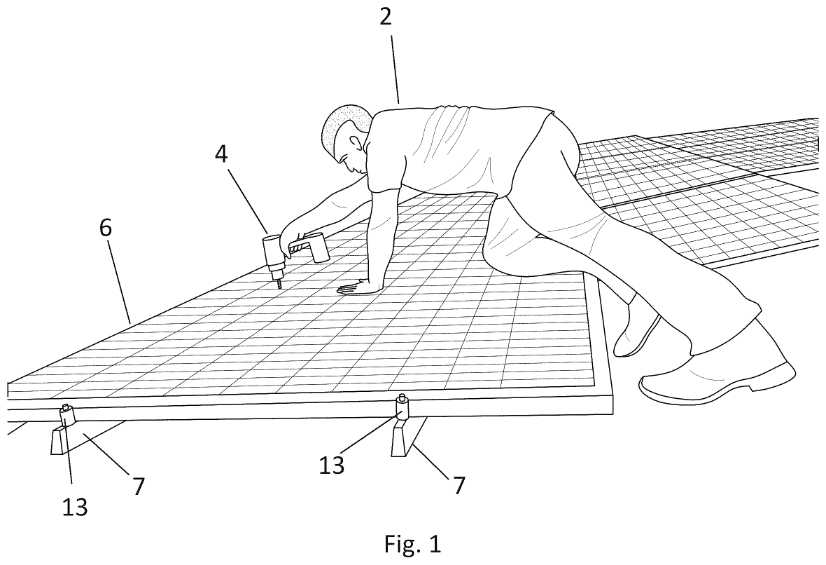

FIG. 1 illustrates a solar panel installer utilizing the typical method of installing a solar panel. The installer 2 is utilizing a power drill for typically having a socket to install a retaining bolt to retain the panel to the frame. The retaining bolts run through a clamp which tightens the clamp to the panel in various ways. A series of solar panels 6 are installed on a framework 7. Typically the solar panels are connected on the edges or fringe of the solar panel by a clamp 13. It is illustrated that the installer has to bend or hunch over to reach each bolt install location.

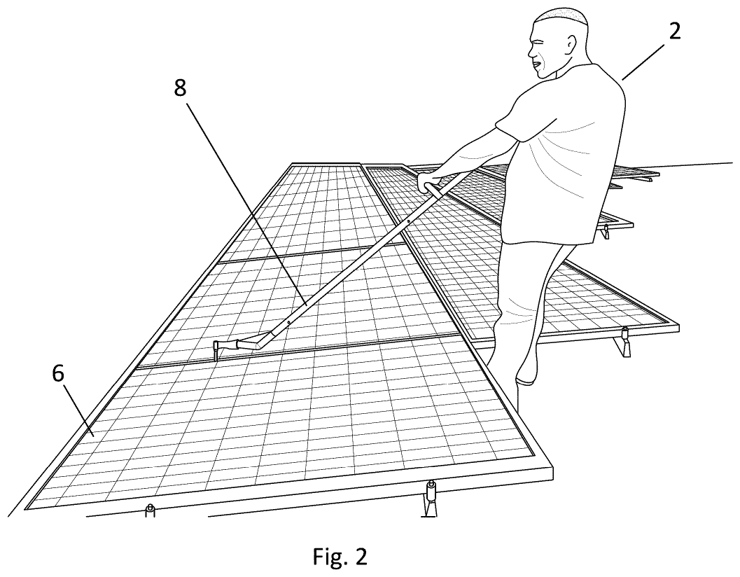

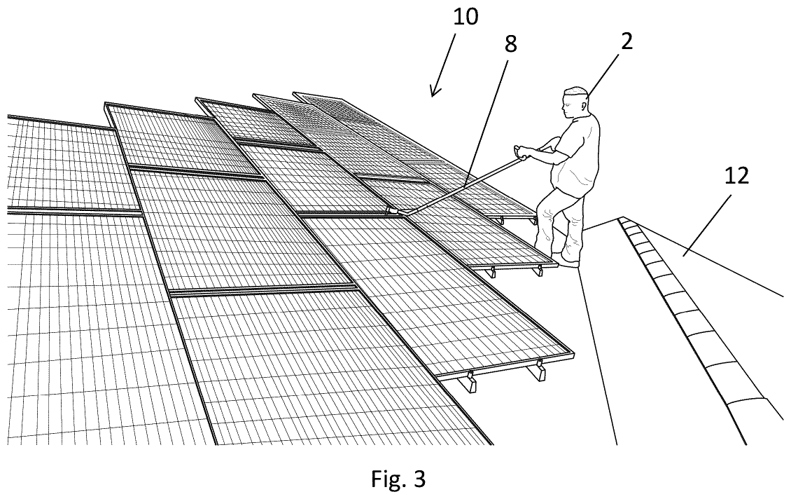

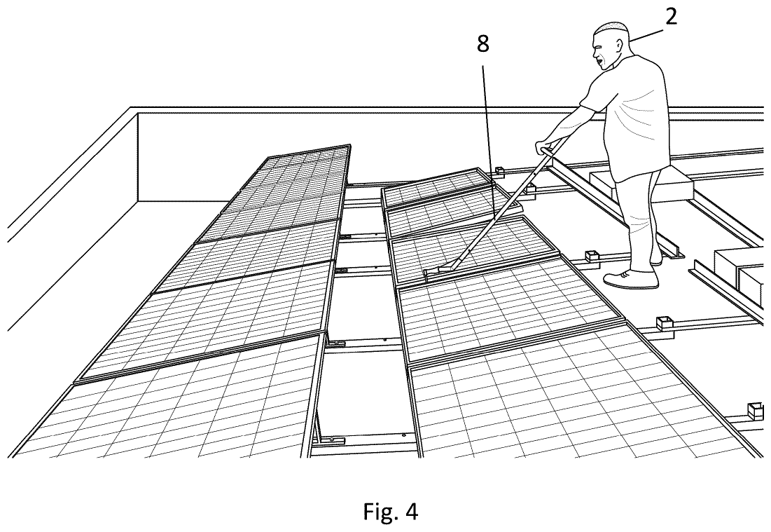

FIGS. 2-5 illustrate different instances of improved installation technique facilitated by the current invention. As illustrated, the installer 2 is now able to stand and reach the bolt clamps by using the tool 8. The tool has an elongate shaft, with having a first end to which the drill is attached and a second end that is functionally connected to the drill. Thus, the operation of the drill at the first end causes the rotation of a socket, plug, or drill bit at the opposite end. FIG. 2 illustrates installer installing the solar panels on a roof. FIG. 3 illustrates a roof installation in which the installer is standing on the downward side of the roof from the panels. FIG. 4 illustrates a similar installation mechanism on a flat roof and which the panels are positioned separately at an angle.

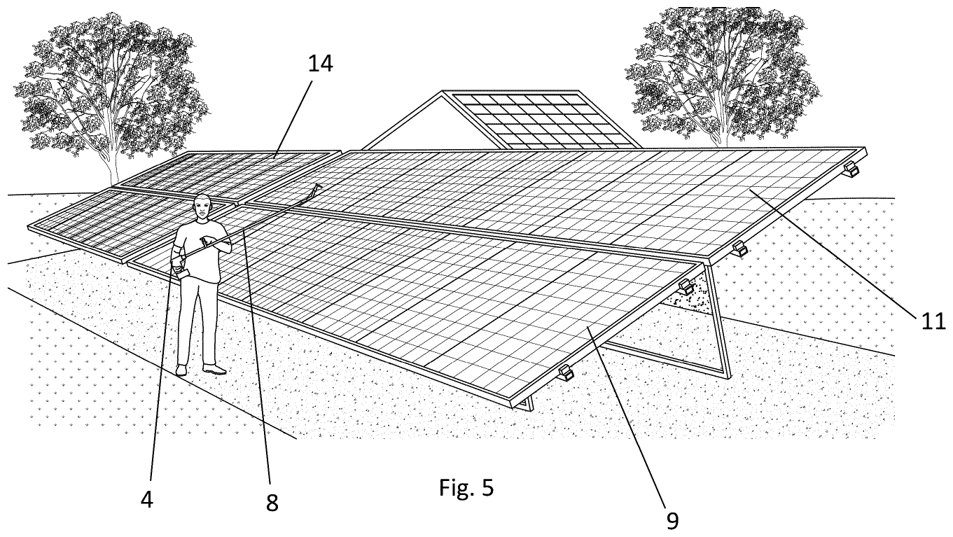

FIG. 5 illustrates the installer adjusting clamps on a ground based frame support. The user is able to reach each of the clamps on the lower section 9 of solar panels even with the upper section 11 already installed.

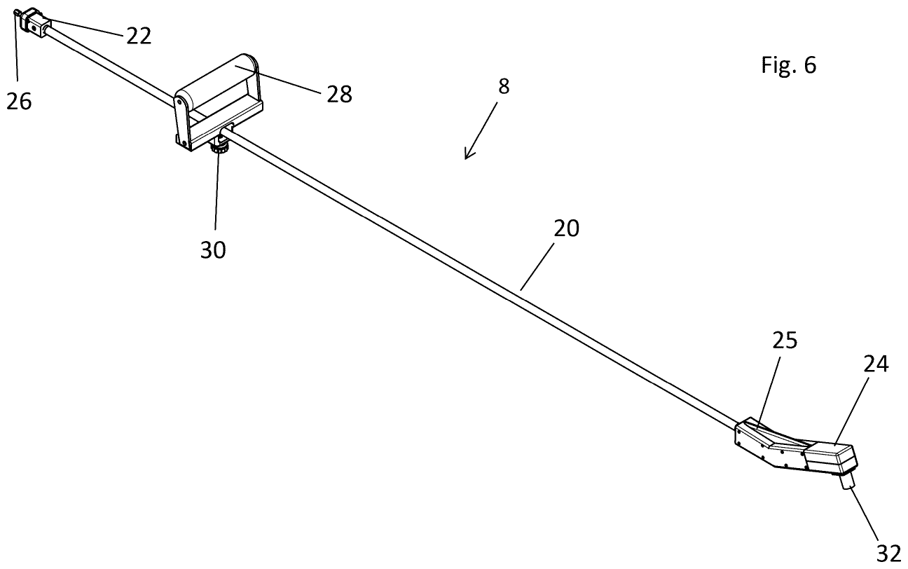

FIG. 6 illustrates a perspective view of a preferred embodiment of the invention. The drill bit extension 8 of the first end 22 and a second end 24 separated by an elongate shaft. The first end is configured for rotational connection to a drill. In the depicted embodiment, the first end has a tang that is connectable to a drill. The first end can be configured to attach to an impact driver and/or a drill. The shaft 20 houses a rotational transfer drive that transfers the rotational application of the drill onto the tang 26 through the shaft to the second end 24 of the extension tool. Preferably a torque limiter is positioned within the drive line, either forming the drill adapter, positioned along the driveline, or connected to the end adapter (such as a socket adapter).

The shaft is a rigid, preferably hollow shaft having a rotational drive line extending from the first end to the second end of the tool. The second end 24 has a socket adapter connected to or formed in the second end of the tool.

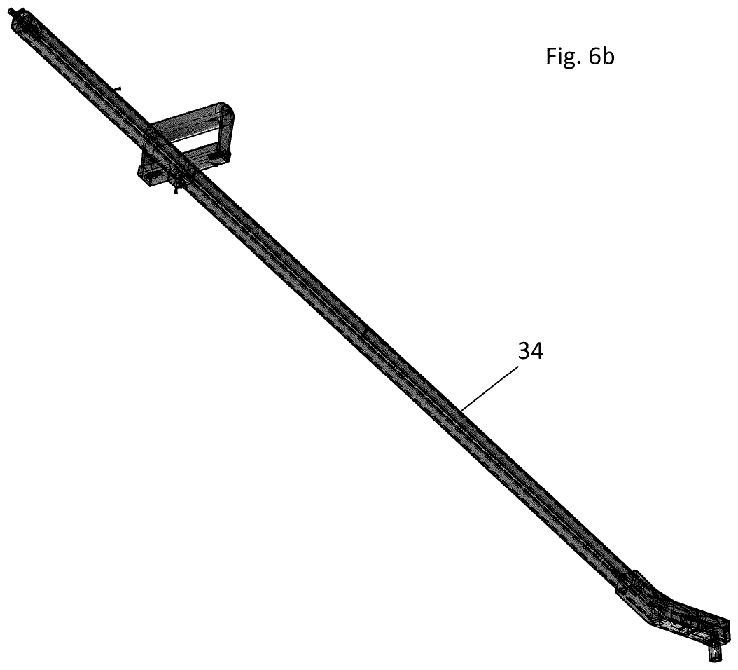

The socket adapter is rotationally connected to the internal drive line of the tool 8 positioned in the shaft 20 the second end 24 is formed as an angled head 25. The angled head has a preferably 22.5 degree angle relative to the shaft, as shown in FIG. 7. The 22.5 degrees is a preferred angle for tightening the solar panel clamps, and is thought to be useful in a multitude of other applications beyond the solar industry. In alternate embodiments the head can be adjustable, such as a ratcheting mechanism with a locking pin, or otherwise to adjust the angle of the head. The head 25 is rigid and houses internal components to transfer the rotational energy to the socket 32. On the depicted embodiment a socket adapter is used, alternate attachments to the end of the head can be utilized, such quick connect for impact driver tangs to allow for the use of impact driver sockets.

The shaft has a handle 28 that allows the user to grasp the handle with user's opposite hand from that operating the drill. Preferably the handle is adjustable in position on the shaft. In the depicted embodiment the handle has a threaded connector 30 for securing the handle in position on the shaft. Alternatively, the handle can be made to be moveable between preset detents on the shaft.

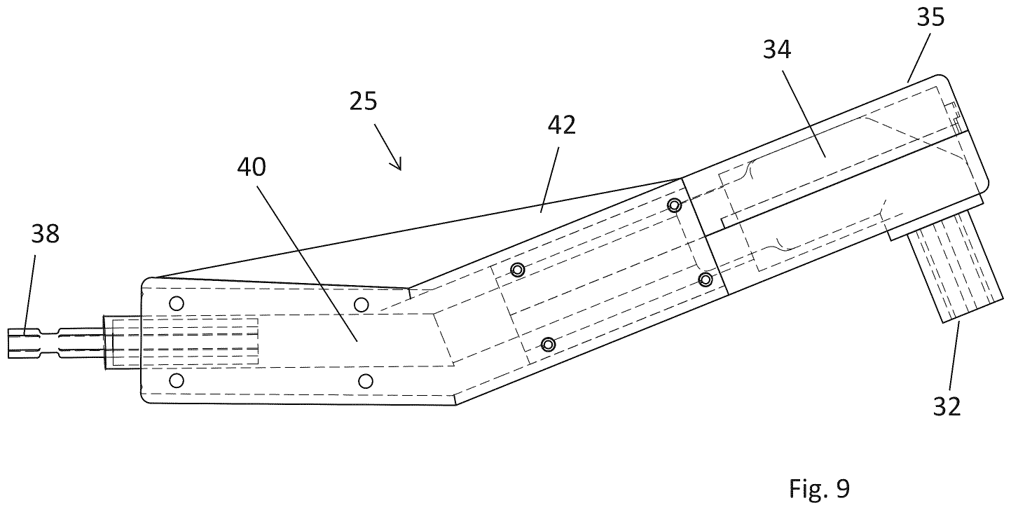

FIG. 6 illustrates perspective view of the embodiment of FIG. 6 with the internal components of the drill bit extension shown in dashed lines. The drill bit extension has a rotational drive line 34 housed within the shaft. In the depicted embodiment, the shaft is constructed of a hollow square aluminum pipe. In a preferred embodiment, the shaft extends 52 inches between the tang at the first end of the tool and the head of the tool. In the depicted embodiment, the tang is functionally connected to a square plug 106 that houses a torque limiter that limits the rotational energy of the tang 26 to transferred to the internal drive line of the tool. A preferred embodiment of the plug is illustrated in FIG. 10. The plug inserts into an end of the square aluminum pipe.

FIG. 7 illustrates an isometric view of the embodiment of FIGS. 5-6. FIG. 7 illustrates the approximately 22.5 degree angle that is provided by the angled head. This angle allows a user to hold the tool with one hand on the handle and a second hand operating the drill, allowing the user to tighten mid/end clamps without having to bend over or otherwise reach.

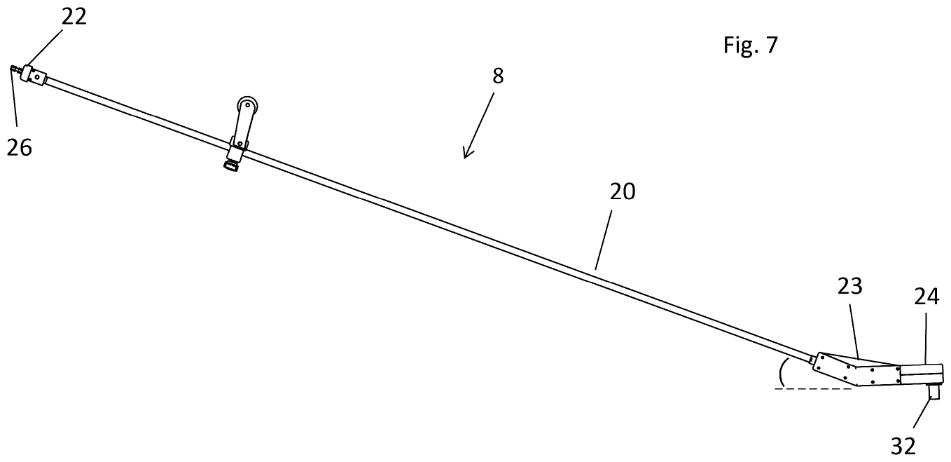

FIG. 8 illustrates preferred embodiment of the internal components of the drill bit extension. The tang 26 is operatively connected to the drive shaft 34. Within the head is a flexible drive line 35 connected to the drive line 34. The flexible drive line is connected to a converter 36 to an angle converter 36 that provides a 90 degree corner to the socket adapter 32.

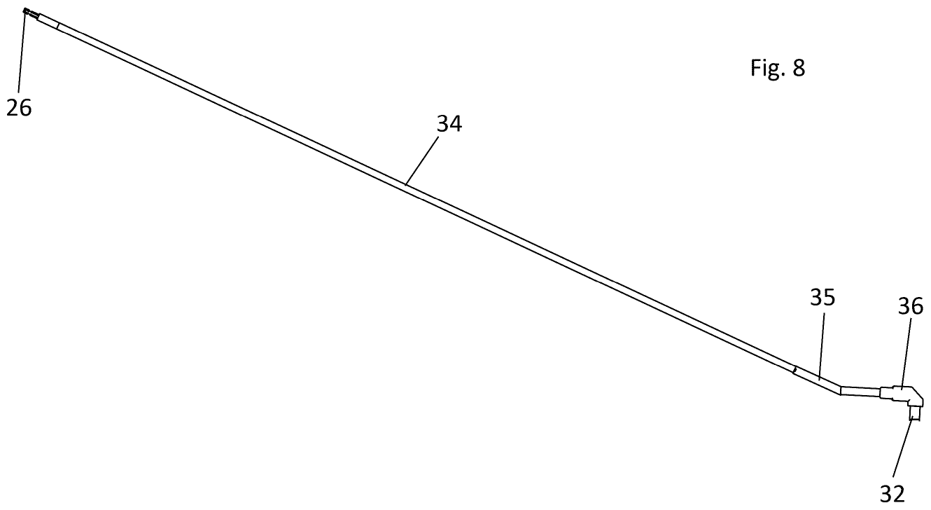

FIG. 9 illustrates a preferred embodiment of the 22.5 degree head. In a preferred embodiment the head has an input tang 38 that transfers rotational energy from the primary drive line of FIG. 8 to the socketed after 32. A head drive line 40 is positioned within the head 25. The corner adapter or 90-degree adapter 34 is positioned at the end of the head to provide a 90 degree direction change of the drive shaft to transfer the rotation movement of the drill to the socket adapter 32. In the depicted embodiment, a reinforcement frame 42 is provided on the top of the head to reinforce the angled elbow of the head.

FIG. 10 illustrates a preferred embodiment of the plug that is positioned into the square tubular housing body. The plug is secured into the tubular body by screws or bolts that insert the side walls of the tubular body and into threaded openings 51 in the side of the plug. The input tang 26 is illustrated. The tang is formed as part of an insert that inserts through a center conduit in the plug. The insert has a first end that forms the tang 26 and a second end providing a socket 53 into which a tang of the driveline is positioned, thus transferring the rotational energy from the end tang in the tang 26 to the to the tang of the driveline.

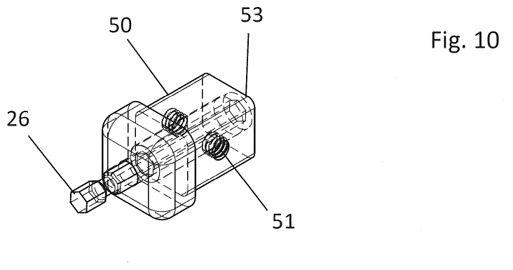

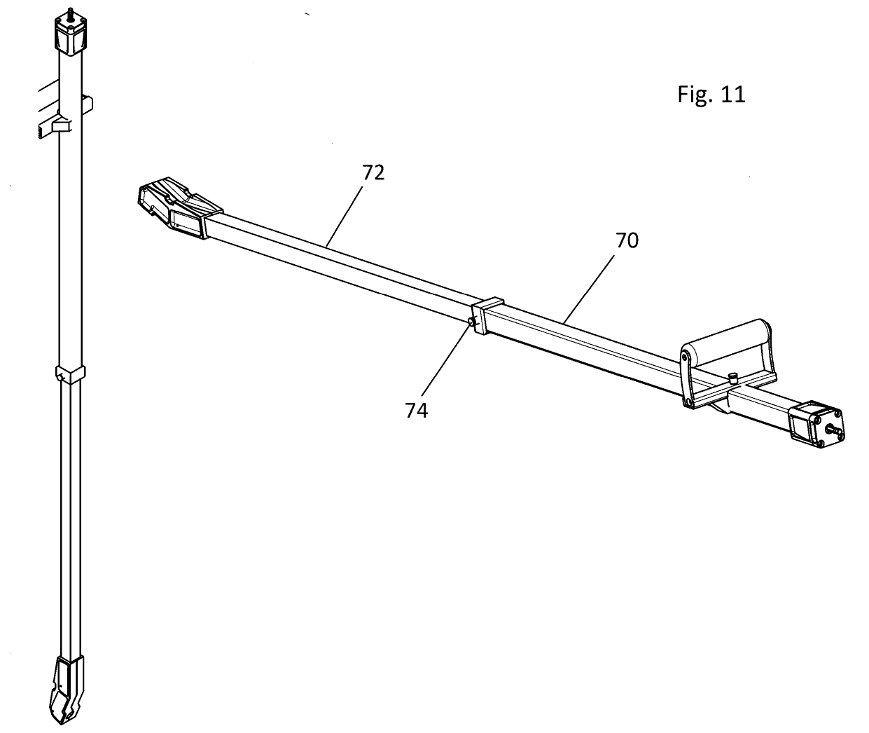

FIGS. 11 and 12 illustrate a second preferred embodiment of the invention. In the embodiment depicted in FIGS. 11 and 12, the device is made to be collapsible, also called a adjustable in length. In the depicted embodiment the shaft is formed of two sections 70, 72, which are configured to be telescoping on one another. The two sections are configured to be locked into position by connector 74 which is moveable between an open or released positioned or a closed or restricted position in which the 2 sections are prevented from telescoping. FIG. 12 illustrates the internal components of the adjustable length drill bit extension. The driveline is configured to be telescoping upon what is Figure b telescoping as well with two adjacent sections 78, 80 that are configured to telescope. The telescoping action of the telescoping driveline 76 is configured to for movement when the outer telescoping housing of FIG. 12a is moved inward and outward.

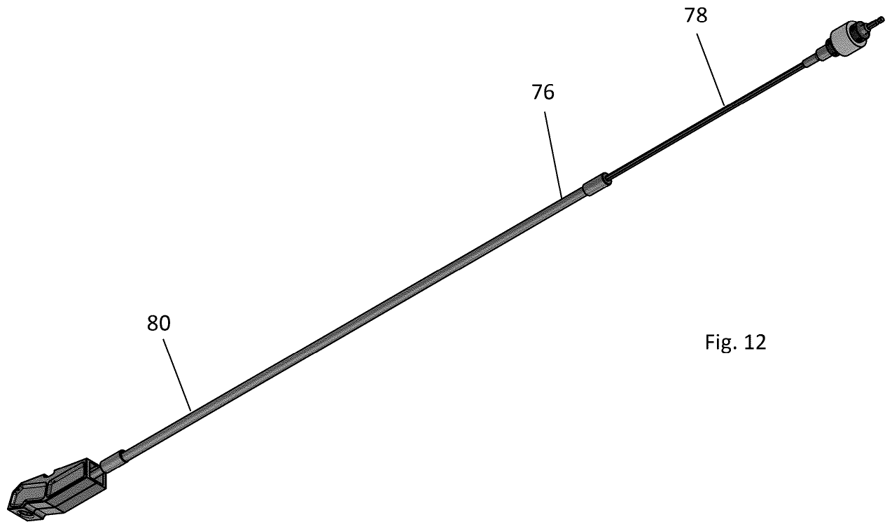

FIG. 13 illustrates an embodiment of the shaft in which the handle is configured to both fold as well as for adjustability and location to preset detents 64 on the shaft 60. The handle is moved by releasing the locking mechanism 66 which can be a spring pin. FIG. 13 illustrates the handle in a graspable position 68 or as FIG. 13a illustrates the handle on a flat position. The handle is rotatable about the base 70 of the handle. The base 70 of the handle is configured to slide along the shaft between detents when the spring pin is released.

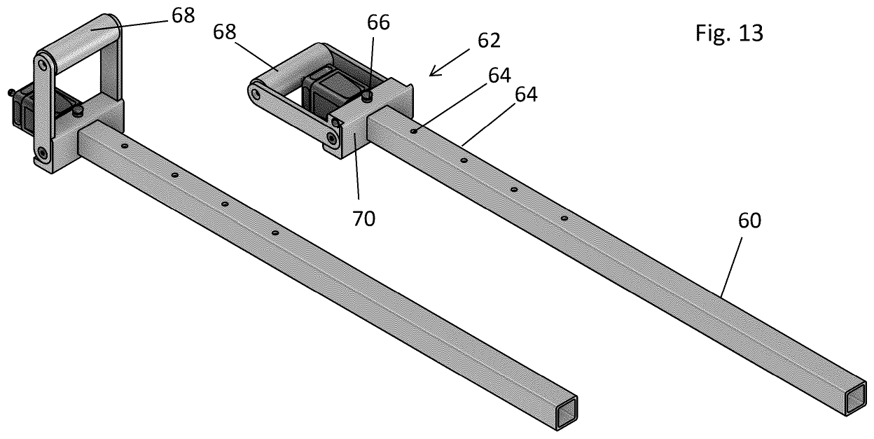

FIG. 14 illustrates a further embodiment of a torque limiter 112 positioned within a torque limiter housing 114. In use, the torque limiter housing is connected to the shaft in the same manner as the insert housing of FIG. 6. The torque limiter receives rotational energy from the drill connected to tang 16 and has torque output shaft 114 that in the assembled drill bit extension limits the torque transferred to the drive line.

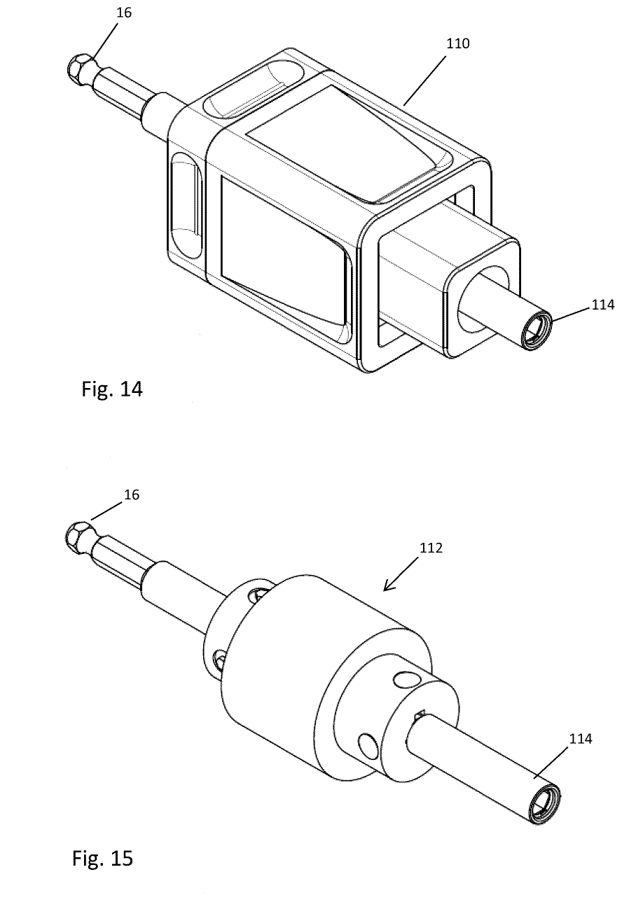

FIG. 15 illustrates an inline torque limiter 112 used in the torque limiter housing of FIG. 14. Alternate torque limiters can be used beyond inline torque limiters. A preferred torque limiter is a 11.2 Nm (Newton-meter) is used, although alternate torque limiters and alternate torque measurements can be used, such as pounds-feet or pounds-inches.

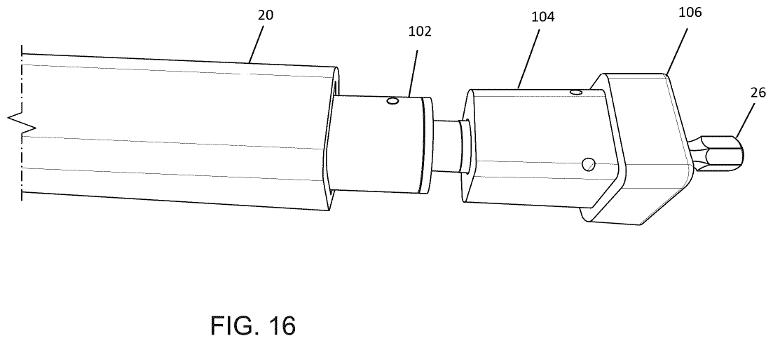

FIG. 16 illustrates a partially exploded view of a first end of the shaft 20 housing a torque limiter connected to the plug 106 forming the drill adapter. The drill adapter plug has an insert portion 104 that inserts into the shaft 20 to connect the plug to the torque limiter and drive line. The torque limiter 102 limits the amount of torque transferred from the drill through tang 26 to the socket adapter to prevent overtightening and damage to the solar panel.

While certain preferred embodiments are shown in the figures and described in this disclosure, it is to be distinctly understood that the presently disclosed inventive concept(s) is not limited thereto but may be variously embodied to practice within the scope of the following claims. From the foregoing description, it will be apparent that various changes may be made without departing from the spirit and scope of the disclosure as defined by the following claims.

1. An socket extension for use with a hand held drill, said socket comprising:
a first end and a second end, and a rigid shaft extending between the first end and second end, wherein the first end comprises a drill connector configured for operative connection to a drill, wherein said second end comprises a head having a socket adapter positioned extending downward from said head, said socket adapter configured for connection to a socket;
a drive line extending within said shaft from said first end to said second end, wherein said drive line is configured to transfer the rotational movement of the drill from said first end to said socket adapter;
a torque limiter functionally connected to said drive line to limit the amount of torque transferred from said drill to said socket adapter;
a handle positioned on said shaft and configured for a user to hole the handle with one hand and to operate the drill operatively connected to the first end with the user's second hand;
wherein said head is at an angle to said shaft such that said socket adapter extends beneath said head when the user is holding the socket extension.

2. (canceled)

3. The socket extension of claim 1 wherein said socket adapter is a ⅜″ socket adapter.

4. The socket extension of claim 1 wherein said drill connector comprises an impact driver tang.

5. The socket extension of claim 1 wherein said head and said shaft each comprises square aluminum tubing.

6. The drill bit extension of claim 1 wherein said shaft is adjustable in length.

7. The drill bit extension of claim 1 wherein said handle is hinged to move from an in use position to a stored position.

8. The drill bit extension of claim 1 wherein said handle comprises an adjustment mechanism for moving the attachment position of the handle on the shaft.

9. The socket extension of claim 1 wherein said drive line comprise a flexible drive line.

10. The socket extension of claim 1 wherein said head is angled at a 22.5 degree angle to the shaft.

11. The socket extension of claim 1 wherein said shaft is one piece.

12. The socket extension of claim 1 wherein said head comprises a 22.5 degree elbow connected to said shaft, wherein said drill bit adapter extends at ninety degrees from said head.

13. A drill and socket extension comprising:
a drill
a socket extension operatively connected to said drill, said socket extension comprising:
a first end and a second end, and a rigid shaft extending between the first end and second end, wherein said second end comprises a head having a socket adapter positioned extending downward from said head, said adapter configured for connection to a socket;
a drive line extending within said shaft from said first end to said second end, wherein said drill is operatively connected to said drive line at said first end, wherein said drive line is configured to transfer the rotational movement of the drill from said first end to said socket adapter;
a handle positioned on said shaft and configured for a user to hold the handle with one hand and to operate the drill operatively connected to the first end with the user's second hand;
wherein said head is at an angle to said shaft such that said socket extension extends beneath said head when the user is holding the socket extension.
